(19) United States
(12) Patent Application Publication
(10) Pub. No.: US 2012/0168185 A1
(43) Pub. Date: Jul. 5, 2012

(54) Remote Automated Wildfire Protection System

(75) Inventor: John Charles Yount, Pollock Pines, CA (US)

(73) Assignee: John Charles Yount, Pollock Pines, CA (US)

(21) Appl. No.: 12/981,067

(22) Filed: Dec. 29, 2010

(51) Int. Cl. A62C 35/00

(52) U.S. Cl. 169/16

(57) ABSTRACT

An outdoor system for mitigating the effects of wildfires on structures encourages implementation because of a low cost design and installation and because of a low impact on property aesthetics resulting from remote placement relative to the protected structure, assures testability because of minimal consequences of dispersal of non-corrosive fire retardant such as commonly available water, maximizes reliability by minimizing the number of elements that must all operate in series, compared to alternatives systems; and minimizes false alarms by using a hair trigger that must experience the direct environment of a wildfire.

### FIELD

Embodiments address devices and methods for mitigating the effects of a wildfire propagating along the ground and in the outdoor environment before it reaches the protected structures.

### BACKGROUND

Wildfires destroy structures mostly because of the fire ignited by ground level embers propelled and fanned by the wind. Existing known systems to mitigate fire damage focus on dousing a fire too late, where the fire has already started inside a structure. Other known systems initiate dispersal of fire retardant, extinguishing material or moisture on the protected structure, instead of between the structure and the fire. Other systems use gas or electric pumps and are connected to an expensive, limited amount of water i.e. storage tank, instead of using commonly available water. All the known systems require failure-prone, complex systems with multiple single-point failure nodes.

Systems using a horizontally strung cable comprising multiple weak links to suspend weights have been used to turn valves that control dispersal of a fire retardant. The known systems use weak links whose response times are so slow that the fire is in contact with the structure before system activation. The response typically incurs a time delay of order more than tens of seconds after a fire starts somewhere, because of the thermal mass of the weak link. These methods teach away from using weak links with melt temperatures above the boiling point of water.

Warning systems designed for exterior environments exposed to the elements are typically quite complex and use more than just water for mitigation. Fire retardants other than water are typically known to be costly, approximately $1000 per dispersal event.

Spray systems to reduce or mitigate wildfire are orders of magnitude more expensive than the cost of a water valve, which strongly discourages the tendency to be implemented.

### SUMMARY

The problem of assuring implementation of a reliable wildfire mitigation system is shown here to be solved by 1. placing a hair trigger valve system and a fire retardant or moisture dispersal system at a distance outside of and well upwind of the protected structures; 2. using a weak link to release a weight which will open the dispersal system valve when the link is weakened or destroyed directly near or in the wildfire; 3. minimizing the number of system failure nodes that must function in series; and 4. using inexpensive and readily implemented parts and methods. The weak link is designed as a “hair trigger” so that it releases the weight, which releases fire retardant, and spreads fire retardant faster than the fire's embers can travel to the protected structure from the remotely located, weak link. Water sprays at least into the region between the protected structure and the fire, which mitigates the usual, most probable ignition mode. Using only water or water without expensive, corrosive or expensive additives, encourages outdoor system tests and increases quantifiable reliability in part because of the low cost and because of the low consequences of water dispersal in the outdoors.

One embodiment uses a weak link suspension configured to support a heavy weight. When the wildfire engulfs the weak link, the suspension burns, weakens or otherwise fails. Within seconds the heavy weight then falls. When the weight is directly connected to a lever of a water control valve, it opens the valve in a single motion and initiates flow. The most convenient and yet effective fire cooling agent is water. The water flows to a system typically including plurality of sprinklers. The sprinklers insert moisture into the air and on the combustible material near the ground between the wildfire and the protected structure.

The problem of preventing or mitigating loss of life and destruction of property due to a wildfire is also shown to be substantially solved by using a high reliability system that is highly likely to be implemented.

Implementation is encouraged at least because the system is designed to be simple and low cost. Reliability assurance is enhanced by a testing procedure whose clean-up consequence is indistinguishable from turning on a yard irrigation sprinkler. Embodiments detailed here show a device having only a small number of parts that must all operate in series during a wildfire and all of which are inexpensive, clearly simple to install, inspect, periodically test and operate. Embodiments emplace multiple hair trigger valves sufficiently close together and in parallel along a perimeter to form a continuous fence crossing all probable paths a wild fire is likely to take on its way to a protected structure. Other embodiments use a horizontally suspended hair trigger to span the probable wildfire paths.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present teachings.

FIG. 1 schematically shows a protected structure dozens of meters down wind of a typical wild fire approaching along the ground, a hair trigger valve immersed in the fire, and a water sprinkler between the fire and the protected structure.

FIG. 2 schematically shows a hair trigger valve including a heavy weight configured to open the valve by pulling on the valve lever when the suspension predictably fails upon immersion in the environment of a wild fire.

FIG. 3 schematically shows a long, horizontal tensile weak link connected to a valve lever configured to have both a vertical and horizontal attachment point, providing a greatly increased exposure for weak-link immersion in the environment of a wild fire.

FIG. 4 schematically shows a fence element configured with protecting structures protect the long, horizontal tensile weak link from breakage, for example, by providing a perch for birds above the link and a barrier below the link to diminish breakage by animals or humans.

FIG. 5 schematically shows a hair trigger valve and a heavy weight connected together and their junction connected to a slack coupling configured to jerk open the valve when the slack suspension predictably fails upon immersion in the environment of a wild fire.

FIG. 6 schematically shows a long tensile weak link supported at various points along its length by loose, small loops.

### DETAILED DESCRIPTION

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

FIG. 1 shows a mitigation embodiment to disperse water, a fire cooling agent, along the ground ahead of the endangered structure and directed primarily along the wildfire fuel path. This minimizes propagation of the fire along the ground. Wildfire spreads mostly along the ground, and some travels along a region in the air less than several feet above the ground. Ground propagation causes the largest number of fire ignitions. The mitigation embodiment emphasizes arresting a near-ground- and ground-propagated fire. The embodiment also disperses water to add moisture and high humidity to the outdoor environment directly to a region upwind of and ahead of the area or structure to be protected. This dampens the wildfire propagation before it can destroy. Embodiments may use benign additives with the water, such as inexpensive additives that are not corrosive and have low impact (clean up) after live system tests. For example, Dawn soap at 0.1% per gallon can be used in a way similar to commercial “snow emulators”.

In FIG. 1 a wild fire 101 approaches a protected structure 100 from the upwind direction (from the right, to the left) along the ground. Well before reaching the structure the hair trigger valve 102 is engulfed by the fire. This hair trigger experiences a temperature well above the boiling point of water. The hair trigger weakens or fails, the weight falls and opens the valve, and valve 102 releases the water into the sprinkler system 103 between the hair trigger valve 102 and the protected structure 100. Note that a “hair trigger” is designed to fail at temperatures associated with immersion in or exposure to a wildfire, and hence may be designed to fail above the boiling point of water. The failure temperature is an allowed design option to enable trade-offs accommodating other constraints, such as weather and UV endurance.

An embodiment uses commonly available water, such as fresh, brackish or salt water, as the fire cooling agent. Water incurs a minimum of cleanup consequences and is also useful as a sprinkler. Although the common fire retardant alternative only costs about $1.50 per gallon, it is highly corrosive and incurs about $1000 in a typical event. Low consequences resulting from using commonly available water also enhance the incentive to test the system. Testing is necessary to sustain its reliability.

An embodiment uses a low cost, easily replaced hair trigger. For example, a hair trigger can be a fibrous link such as typical types of robust string used at a construction site. Many types of hair trigger can be used. For example, the materials can be ribbons, which have a large area per length, or they can be hair-thin wires, which can quickly reach the yield point in a fire environment

The design requirement for the time within which a hair trigger, weak link must weaken or fail is given by a time that is sufficient to give the sprinkler a chance to wet the environment ahead and upwind of the protected structure. This time is nominally about 2 seconds. The “2 seconds” refers to the time it takes to disperse water ahead of the embers and before the fire front or hot ember stream reaches the protected structure. This number can vary depending on many factors, including terrain, and combustibility. The more intense and wind driven the fire the quicker the activation (weak link failure). Activation is likely to occur well ahead of the fire front due to hot thermal gases traveling near the ground. Since wildfires can travel at the wind speed, this implies approximately about 1 second for each 100 feet of distance between the water dispersion system and the protected structure. The nominal values of hair trigger response are between 1 and 10 seconds.

Even though conventional fusible links melt at temperatures substantially below the boiling point of water (150-170 Fahrenheit), they have a thermal mass sufficient that can cause them to take longer than several seconds to fail. A low intensity fire (smoldering) with little flame propagation may never activate a system but could cause huge loses do to smoke. A preferred weak link fails within 1 or 2 seconds of exposure to the environment of a wildfire.

A hair trigger of an embodiment is designed to respond in less than a nominal 10 seconds, in an extreme case, and preferably within 2 seconds, to accommodate the high ground speed of a wildfire. For example, a string, fibrous material, composite or very thin metal wire or tensile link has relatively fast response times. One embodiment of a hair trigger design uses a link that is chemically reactive in a fire, for example, a combustible link such as strings, ribbons, ropes, cords, twine and very thin metal wire. Another embodiment of the hair trigger design uses a material with a low thermal mass, such as kite strings, compared to the thermal mass of conventional fusible links. Another embodiment uses materials that respond to outdoor fire temperatures, at least 100 degrees Fahrenheit above the boiling point of water. This element contrasts most existing indoor application weak links such as those using metals or materials that melt soften or undergo plastic deformation or a glass bulb with liquid that fails at temperatures above ambient but below the boiling point of water. A design element chooses a weak link from materials that resist degradation by extreme environmental conditions such as UV, moisture, fog torrential rain, snow freeze, sleet, the heat or cold of weather extremes, plastic deformation, salt air intrusion, strong abrasive winds, contact from falling material (leaves, limb, needles), animal droppings, bees and birds nests, light impact damage, industrial pollution, and chemical sprays.

A requirement needed to encourage implementation and system tests includes the minimizing of consequences from either a deliberate or a false alarm trigger. Vandalism and deliberate system tests, both false alarms, result in a fail-safe discharge of sprinkler water. The associated shut-off mechanism must be relatively easy and obvious, for example, as shown by embodiments where the valve has an obvious, visible handle that is easily turned off. The consequence of water discharge is equivalent to outdoor sprinkler irrigation. The integrity of the system is easily verified because all the moving elements, only two of them, are in the open and easily inspected. Because the dispersing sprinklers can be located remote from the hair trigger and valve, a person may not need to cope with the wetness of the sprinklers or sprinkler field, again encouraging system tests and enhancing reliability.

A requirement needed to enhance credibility of the reliability of the system is the ability to test the system without expensive consequences or a messy clean up. Embodiments of the invention that use only water as fire cooling agent, valves with simple, visible on-off levers and inexpensive, easily installed weak links will satisfy this requirement.

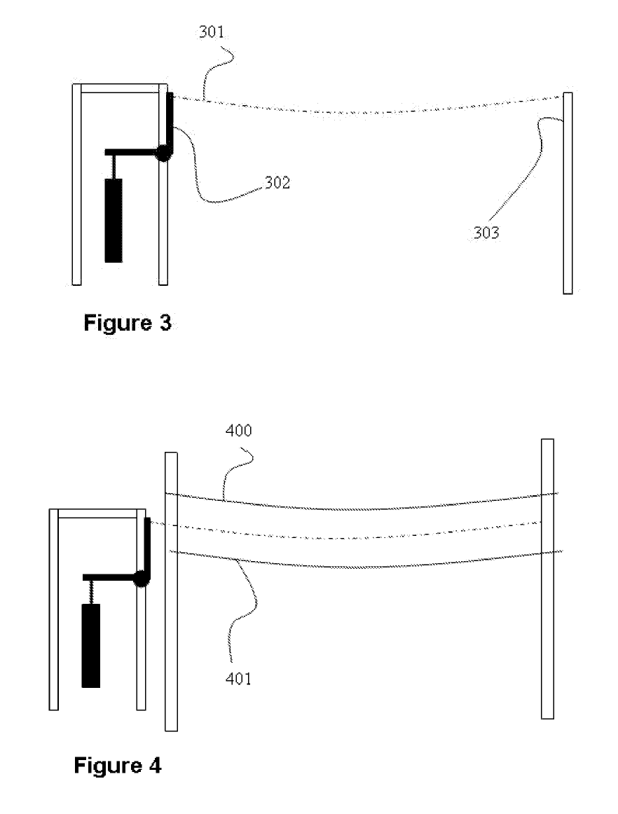

An embodiment uses only mechanical, non-electronic, non-programmable systems with a small number of simple elements in series that must all function, as shown in FIGS. 3 thru 5. This greatly enhances reliability. The embodiment uses no pulleys, gears, gear pulleys, or spring loaded devices. Competing systems using computers and programmable systems can incur multiple failure modes, including one or more of operator interface confusion, software bugs, power supply interruption issues, power supply energy storage issues, long term system memory issues, heat and cold temperature limits, static discharge issues, to name a few. Embodiments of the system operate even when all electronic systems fail.

An embodiment uses two or more hair trigger systems in parallel, so that any one of them can energize the water dispersal. The hair trigger system uses a single valve with a single lever for shut-off/turn-on motion where the lever moves no more than 180 degrees. The motion to activate is simple and direct and known to be reliable, and the motion to turn off or deactivate is similarly simple. A single, free-swinging, long and narrow heavy weight pulls the lever or jerks a loose coupling to jerk the lever. A single hair trigger, weak link exposed directly in the wildfire environment maximizes response to a real fire and minimizes false alarms. In contrast, electronic algorithms to distinguish fire from naturally occurring, similar but false signatures are known to be plagued by false alarms. The hair trigger system is also be located remotely to deliberately place distance and time between fire and protected structure.

A preferred embodiment places the hair trigger system remote from the protected structure and thereby initiates fire mitigation before the protected structures are threatened directly. Remote placement is an important element and also locates the hair triggers out of easy reach by vandals such as mischievous juveniles. A remote, almost non-visible set of hair trigger systems also does not visually decrease the property values or affect the esthetics. This form on non-impact by our embodiments also tends to encourage implementation.

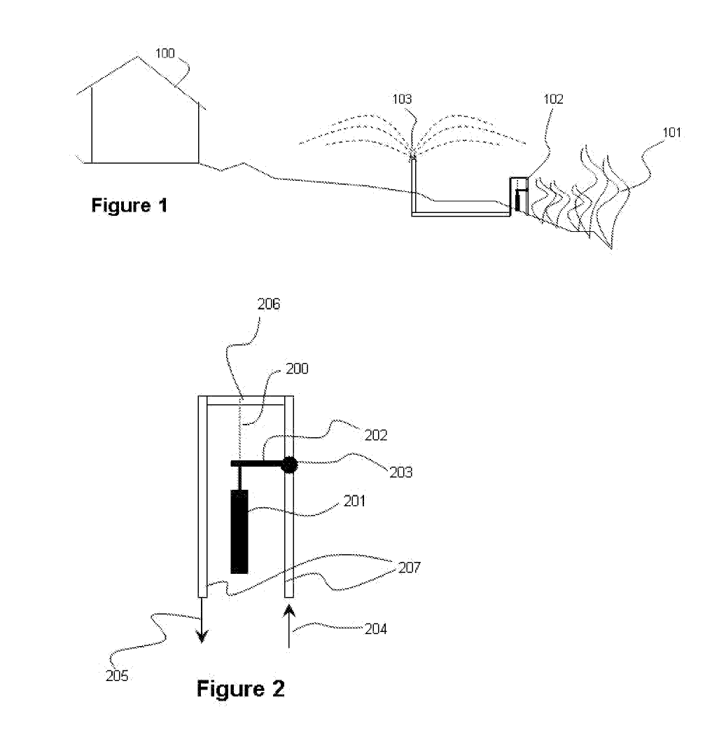

An embodiment sketched in FIG. 2 shows a ball valve 203 controlling the water flow 204, 205 through the water pipe 207. A hair trigger, weak link 200 suspends a weight 201 attached to the valve opening lever 202. When the weak link is weakened or ignited by the wildfire, the weight falls, turns the lever and opens the water valve. The plurality of sprinklers connected to the water output 205 then spray moisture into the environment, causing the combustibles to become wet and non-combustible and also cooled below ignition temperature.

A particularly useful embodiment includes a single, input water pipe rising from underground substantially vertically for more than 2 feet, with-a horizontal segment approximately 6 inches in length and final elbow providing a vertical pipe back to underground. This provides convenient attachment points for the hair trigger. The output of the water pipe feeds a sprinkler system. The valve may be on either the input or output vertical pipe segments. A valve on the input side presents certain advantages, such as an ability to include sprinkler holes directly on the structure 206, 207 to cool it. The weak link is protected from being bumped by the piping that surrounds it on three sides.

Other types of valves can be used, such as butterfly or flapper valves. Other types of emplacement can be used. The main requirement is that the hair trigger must be placed in the thermal profile, or heat signature of the fire, which is usually most extreme at height below about 20 feet.

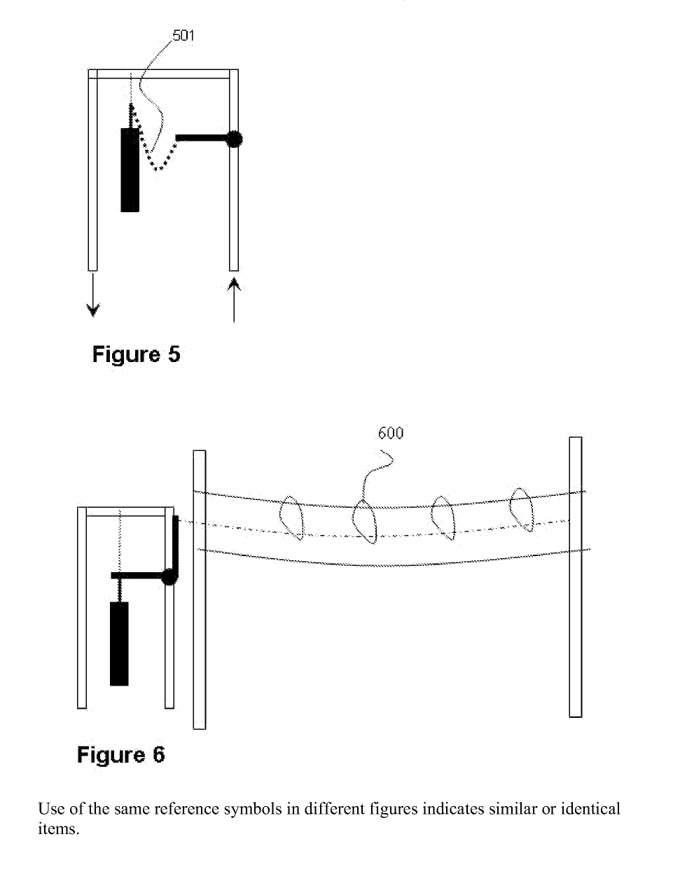

As shown in FIG. 5, a preferred embodiment has a weight connected to one end of a slack connection and the other end connected to the valve-opening lever. This permits the weight to acquire some kinetic energy before the slack connection becomes tight. This provides a jerk to release any inadvertent stickiness in the valve opening mechanism. The moving element of the valve may also be coated with white lithium grease, which is known to prevent valve sticking in harsh mud/weather/dust environments such as on farms. For example, a light film of spray on white grease on both sides of the ball valve will assure smooth operation.

An embodiment useful where the freezing temperatures are an issue includes a valve on the input water pipe that is below the ground and below the depth of ground freezing and configured to self-drain when no water is demanded. This kind of valve, referred to as a drain down valve, is common on ranches in the northern latitudes. A single lever operates the valve. The hair trigger mechanism to operate this can take on many forms. One form uses the motion of the weight to lift or push the activation rod, as required, extending from above ground to the valve below ground. In this way, the system is automatically winterized upon installation. Another embodiment inserts air to replace water wherever the water would freeze. This can be done on the output side of the flow control by pressurizing the system with air, for example, using conventional air pumps and valves connected to the output side.

A horizontal segment 206 shown in FIG. 2 provides a convenient fastening region for the hair trigger weak link. The horizontal segment can be a part of the water pipe itself. The weak link can be a fibrous link such as a construction line string. A fibrous link string can be conveniently wrapped or looped around the horizontal segment.

Additional small holes, not shown, can be drilled into the down stream pipes, such as on the horizontal segment 206, to provide spray cooling mist or water on or around the vicinity of the mechanism and the pipes. In most cases the water flow through the pipes will cool them, preventing either steam generation or melting. Some PVC pipe in some extreme conditions may be destroyed without this feature. An embodiment may include such cooling vents designed to spray cooling water on to the valve, the associated mechanism and a major portion of the supply water pipe. An embodiment includes metal elbows and metal pipes, such as galvanized elbows, and also mitigates against fatigue cracking and breakage. Galvanized elbows at the bottom, underground feed pipes, instead of PVC elbows, would accept the load and jerk.

A preferred material for the fibrous, weak link is construction line string. For example, one can use 50# Dacron kite string from the manufacture Shanti Line Company. Considerable experimentation was required to find this commercially available material that resists degradation over time and under a wide range of conditions. Degradation includes, for example, plastic elongation or decomposition due to weather, UV exposure, and normal extremes of climate temperature. Fishing line undergoes plastic deformation and UV degradation. Other materials have shown rapid degradation due to moisture and typical environmental exposure. Other materials have failed to ignite or did not fail rapidly enough during the short exposure to the flames of wildfire.

Such a preferred link may be made of materials other than the preferred, fibrous construction line string so long as the materials resist degradation in the expected environments and display the required weak link activation times.

A preferred material for the weak link may be chosen so as to fail in the heat of an outdoor environment exposed to an oncoming wildfire. This temperature is well above the boiling point of water and can be sufficient to weaken brass wire, nylon string, and a large number of materials that are not usually associated with triggers of fire mitigation devices.

When the water pipe exposed to the wild fire environment is made of metal it might not fail when engulfed in the wildfire because of the water coolant. Other fire-resistant materials can be used. The temperatures can exceed the failure temperature of the outside of a PVC pipe, even though water flow can cool the interior.

An embodiment having the weak link 200 shown in FIG. 2 is configured so that the tensile force on a mechanism that opens the valve is predominantly, within plus or minus 45 degrees, along the direction of valve lever motion. The angle constraint limits the required tensile strength to about 30% more than the minimum required. This configuration and embodiment implicitly suggests that the valve should open with less than a 90 degree rotation of the valve lever.

A preferred embodiment uses a substantially horizontal weak link 301 as shown in FIG. 3. This link stretches from the valve opening arm to a securing post 303 placed 2 to 500 feet away. To keep the direction of tensile force along the direction of valve lever motion, a second connection is provided on the valve-opening arm 302, attached to the original valve lever and, for example, at right angles to it. One could use any configuration that lets the weight open the valve by falling and the weak link to pull in the horizontal direction, each without using an additional moving part. In this way the weak link element may be stretched or hung over a much longer distance than the dimension of the system, which includes a valve, weight and pipe elements. The increased length permits separating hair trigger systems by a long dimension and permits covering a larger perimeter per unit cost than a hair trigger using a vertical tensile element.

Birds may perch on this string, breaking the weak link and causing failure and false alarms. Animals or people may run between the hair trigger support elements and break the weak link. As shown in FIG. 4, an embodiment adds at least another element to provide a perch 400 for birds a barrier 401 for blocking animals or humans from breaking the link. Such additional elements would protect the weak link from above and below and could be, for example, a fence wire, cable or perch located above and/or below the weak link element, as shown in FIG. 4. The principle in this embodiment is to protect the hair trigger. For example, a protective, wire mesh cage around the hair trigger would also provide protection against deer, dogs and some vandalism.

FIG. 6 shows how small, loose loops 600 can also support a long hair trigger over long spans. This single, long span hair trigger would obviate the need for multiple hair triggers in rows next to each other. Mechanisms such as pulleys are generally to be avoided because they add failure modes. Pulleys can freeze up in mud and weather. The environment contains many elements that can cause a pulley to jam and fail to turn.

An embodiment uses a simple method to attach the weak link. One method includes a double screw barrel connector to allow simple adjustment of the fibrous link to bring the valve to the fully closed position. One end of the fibrous link is wound around the top of the pipe. The other end is attached to the double screw barrel connector.

And embodiment configures the placement and dimension of the weight so that the weight does not slow down when it is released by the weak link. Friction against the support system or water pipe has been shown to slow the fall. A preferred method to minimize friction uses a long slender form for the weight, such as a length of at least twice a width. Experimentation showed that short fat weights, and round weights, the opposite of long and thin, tend to rub against the support pipe and either fail or require substantially greater weight. Greater weight implies more weak link mass, which undesirably increases the weak link ignition delay. A way to avoid this would orient the support pipe at a canted angle from vertical, even though canting can complicate the design. The simplest design uses the fewest angles and the straightest lengths of pipe. An aspect ratio of about 3 inches diameter to 12 inches length as the geometry of the weight has been demonstrated to be sufficient.

### Testability of Embodiments

Embodiments are designed to be readily testable. For example, a fibrous weak link, a construction line string, can be burned with a portable lighter, a match or a flame. The fibrous link can also be simply disconnected. In both cases, the removal of the support permits the weight to fall, open the valve and activate the sprinkler system.

An embodiment uses water as the cooling agent. It is desirable to use water that does not result in a mess, additional cost or a material cleanup issue. Water from a conventional water source satisfies this requirement, especially water without additional fire suppressant additives.

Cost Constraints

Embodiments take advantage of the extreme simplicity of the fibrous link, valve and water pipe hair trigger system to provide low cost system. An exceptionally important issue directly affecting the ability of a system to mitigate damage from fire is the cost of its implementation. A system is only useful if the user implements it.

Reliability Issues

A preferred embodiment has at most only a few functional elements that must all operate for the system to function. The hair trigger system has 4 such elements: 1. a weak link causing suspension of a weight; 2. a valve opened by a weight allowed to fall; 3. a water source; and 4. placement in the certain path of wildfire. The first three elements are readily tested. The last element is covered by the long horizontal hair trigger or by placement of multiple hair triggers configured to feed water in parallel.

Competing systems such as those including electronics are notorious for malfunctions, including malfunctions resulting from the human interface being difficult to operate.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Although the invention has been described with reference to particular embodiments, the description is only an example of the invention's application and should not be taken as a limitation. Various adaptations and combinations of features of the embodiments disclosed are within the scope of the invention as defined by the following claims.

We claim:

1. An outdoor apparatus to mitigate wildfire ignition of a protected structure, including
a supporting weak link located to be in an anticipated direct path of a wild fire;
the supporting weak link also located where the expected travel time of the wildfire to the protected structure is at least 1 second;
the supporting weak link also constructed and configured to fail when at least one point of the link experiences a temperature exceeding the boiling point of water or becomes directly exposed to the environment of the wildfire;
a weight supported by the weak link, the weight configured to mechanically open a fluid flow valve upon configured failure of the supporting weak link;
the valve configured to supply water to an outdoor dispersal system located between the protected structure and the hair trigger; and
the system also configured to be easily turned off or on by manual intervention.

2. The apparatus of claim 1 wherein the active fire suppression ingredient of the fluid flow is water reliably provided on site.

3. The apparatus of claim 1 wherein
the fluid flow valve includes a ball valve.

4. The apparatus of claim 1 wherein
the valve includes a drain-down valve.

5. The apparatus of claim 1 wherein
the hair trigger is placed within 2 feet of the earth surface.

6. The apparatus of claim 1 wherein
the mechanism to open the valve is a direct connection to the valve that requires less than 180 degrees of valve stem rotation to fully open the valve.

7. The apparatus of claim 1 wherein
the mechanism causing the valve to open configured to require less motion than provided by the length of travel of the weight when it becomes unsupported by the configured failure of the supporting weak link.

8. The apparatus of claim 1 wherein the supporting weak link is placed remotely so as to be directly in the expected wildfire environment and to be upwind of the protected structure by a distance exceeding the distance that known wildfires can propagate during 2 seconds or less.

9. The apparatus of claim 8 wherein the weak link is placed within 2 feet of the ground

10. The apparatus of claim 1 wherein the configuration controlling the dispersal of fire retardant is configured to be independent of the function of any electronic component, gears or pulleys.

11. The apparatus of claim 1 wherein
the supporting weak link supports the weight against gravity;
a link mechanism providing looseness or slack in connecting a point on the opening control element of the valve with a connecting point of the weight;
the looseness or slack of the connecting link to open the valve also configured so that it does not become taught or rigid until the weight has acquired at least sufficient kinetic energy to jerk open the valve.

12. The apparatus of claim 11
wherein the connecting link mechanism includes a connecting element that is slack while the weak link is supporting the weight

13. The apparatus of claim 11 wherein length of the connecting link mechanism is longer than the shortest distance between the connecting point of the weight and the connecting point on the control element of the valve, assuring slack.

14. The apparatus of claim 1 wherein
the weak link is configured to span horizontally.

15. The apparatus of claim 14 where
the horizontal span over which the weak link stretches is greater than 1 meter.

16. The apparatus of claim 15 including
a structure to protect a segment of the horizontal span of the weak link.

17. The apparatus as in claim 16 where
the structure protecting the horizontally spanning weak link includes a fence element.

18. The apparatus as in claim 16 where
the weak link is protected by a fence element above it and a fence element below it.

19. An outdoor apparatus to mitigate wildfire ignition of a protected structure, including
a supporting weak link located over a region including an anticipated direct path of a wild fire;
the supporting weak link also located over a region where the expected travel time of the wildfire to the protected structure is at least 1 second;
the supporting weak link also constructed and configured to fail when at least one point of the link becomes directly exposed to the environment of the wildfire;
a weight supported by the weak link, the weight configured to mechanically open a fluid flow valve upon configured failure of the supporting weak link;
the valve configured to supply commonly available water to an outdoor dispersal system located between the protected structure and the hair trigger;
the valve also configured to be easily turned on by manual intervention; and
the water feed system configured to be easily turned off by supervisory intervention.
